(19) United States
(12) Patent Application Publication
(10) Pub. No.: US 2023/0253644 A1
(43) Pub. Date: Aug. 10, 2023

(54) BATTERY TEMPERATURE ADJUSTMENT SYSTEM

(71) Applicant: HONDA MOTOR CO., LTD., Tokyo (JP)

(72) Inventors: Syuhei KOUCHI, Tokyo (JP); Toru OGAKI, Tokyo (JP)

(73) Assignee: HONDA MOTOR CO., LTD., Tokyo (JP)

(21) Appl. No.: 18/103,122

(22) Filed: Jan. 30, 2023

(30) Foreign Application Priority Data
Feb. 4, 2022 (JP) 2022-016699

(51) Int. Cl. H01M 10/633; B60H 1/00; H01M 10/613; H01M 10/625; H01M 10/663; B60L 58/26; B60L 50/60

(52) U.S. Cl. CPC H01M 10/633; B60H 1/0073; B60H 1/00278; B60L 50/60; B60L 58/26; H01M 10/613; H01M 10/625; H01M 10/663; H01M 2220/20

(57) ABSTRACT

A battery temperature adjustment system includes: a battery; a battery temperature adjustment device; and a control device configured to control the battery and the battery temperature adjustment device. The control device includes: a scheduled travel plan acquisition unit; a normal battery cooling control planning unit configured to derive a predicted battery temperature and a temperature adjustment capability of the battery temperature adjustment device in a normal battery cooling control: and a temperature adjustment plan creation unit configured to: create a temperature adjustment plan for the battery; derive a battery temperature adjustment amount required for making the temperature of the battery equal to or lower than a predetermined temperature when an occurrence of overshoot, in which the predicted battery temperature exceeds the predetermined temperature, is predicted; and distribute the battery temperature adjustment amount based on the temperature adjustment capability of the battery temperature adjustment device before the overshoot occurs.

### CROSS REFERENCE TO RELATED APPLICATIONS

The present application claims the benefit of priority of Japanese Patent Application No. 2022-016699, filed on Feb. 4, 2022, the content of which is incorporated herein by reference.

### TECHNICAL FIELD

The present disclosure relates to a battery temperature adjustment system mounted on a vehicle.

### BACKGROUND ART

In recent years, as a specific measure against climatic variation of the earth, efforts to realize a low-carbon society or a decarbonized society have been actively made. Also in vehicles, a reduction in CO₂ emission amount and an improvement in energy efficiency are strongly required, and a drive source is rapidly electrified. Specifically, a vehicle including an electric motor as a drive source of the vehicle and a battery as a secondary battery capable of supplying electric power to the electric motor, such as an electrical vehicle or a hybrid electrical vehicle, has been developed.

In such a vehicle, normal charging in which a battery is charged by being connected to an external power source or rapid charging in which a current larger than that in the normal charging flows through the battery to charge the battery can be performed (for example, JP-A-2021-48737). Since the battery generates heat during charging and discharging, it is necessary to appropriately cool the battery. In particular, the battery is likely to generate heat during rapid charging. When the battery generates heat at a temperature equal to or higher than a predetermined temperature, a charging output of the battery is restricted from the viewpoint of safety.

On the other hand, in a battery temperature regulation system for an industrial vehicle described in JP-A-2021-48737, when an automatic guided vehicle for a container circulates on a travel route, a battery temperature regulation device is controlled to cool a battery to a pre-charge target temperature from a pre-charge timing to a charge timing.

However, when the battery temperature regulation system described in JP-A-2021-48737 is to be mounted on a general vehicle, even if it is desired to cool the battery to the target temperature before charging, there is a possibility that a cooling capacity of the battery temperature regulation device is insufficient depending on usage conditions of an air conditioning device (air conditioner), and the battery cannot be cooled to the target temperature before charging. On the other hand, when the use of the air conditioning device (air conditioner) is restricted in order to cool the battery, convenience is deteriorated. In addition, not only during charging but also during high-load traveling, an output of the battery may be restricted due to heat generation of the battery.

### SUMMARY

The present disclosure provides a battery temperature adjustment system capable of avoiding in advance restriction to an output of a battery without impairing convenience.

According to an aspect of the present disclosure, there is provided a battery temperature adjustment system including: a battery configured to be charged with electric power from an external power source; a battery temperature adjustment device configured to adjust a temperature of the battery; and a control device configured to control the battery and the battery temperature adjustment device, where: the control device includes: a scheduled travel plan acquisition unit configured to acquire a scheduled travel plan of a vehicle: a normal battery cooling control planning unit configured to plan normal battery cooling control such that the temperature of the battery is within a target temperature range, and derive a predicted battery temperature and a temperature adjustment capability of the battery temperature adjustment device in the normal battery cooling control: and a temperature adjustment plan creation unit configured to create a temperature adjustment plan for the battery; the temperature adjustment plan creation unit derives a battery temperature adjustment amount required for making the temperature of the battery equal to or lower than a predetermined temperature when an occurrence of overshoot, in which the predicted battery temperature exceeds the predetermined temperature, is predicted; and the temperature adjustment plan creation unit distributes the battery temperature adjustment amount based on the temperature adjustment capability of the battery temperature adjustment device before the overshoot occurs.

According to the present disclosure, restriction to an output of a battery after departure can be avoided while deterioration of convenience is prevented.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a diagram showing a configuration of a battery temperature adjustment system 10;

FIG. 2 is a diagram showing a configuration of a temperature adjustment device 16;

FIG. 3 is a diagram showing a configuration of a navigation device 17;

FIG. 4 is a graph illustrating an example of a scheduled travel plan and cooling capacity distribution control;

FIG. 5 is a diagram illustrating a required battery temperature adjustment amount;

FIG. 6 is a diagram illustrating a method for setting a target BAT temperature during traveling;

FIG. 7 is a diagram illustrating a method for setting a target BAT temperature during rapid charging:

FIG. 8 is a diagram illustrating a temperature adjustment capability of a battery temperature adjustment device (chiller heat removal amount): and

FIG. 9 is a flow diagram of the cooling capacity distribution control.

### DESCRIPTION OF EMBODIMENTS

Hereinafter, an embodiment of a battery temperature adjustment system of the present disclosure will be described with reference to the accompanying drawings.

### Battery Temperature Adjustment System

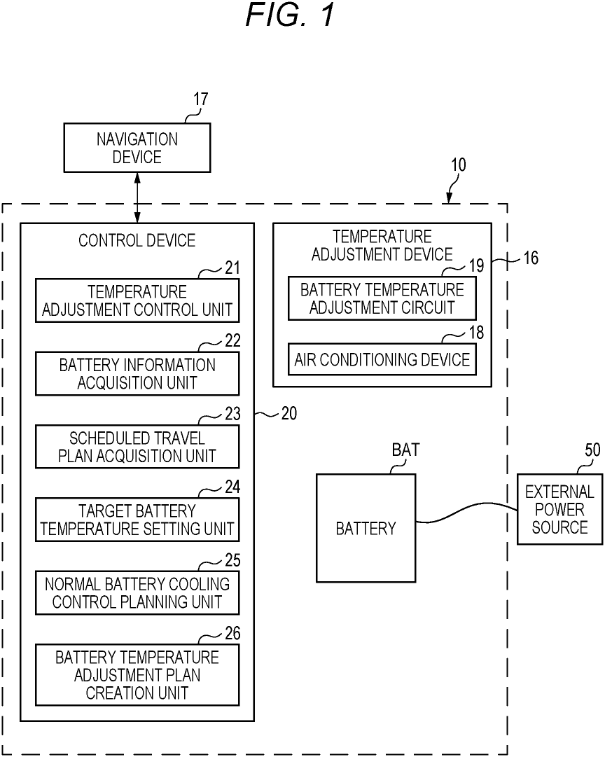

As shown in FIG. 1, a battery temperature adjustment system 10 includes a battery BAT, a temperature adjustment device 16, and a control device 20 that controls the battery BAT and the temperature adjustment device 16, and is mounted on a vehicle such as an electrical vehicle.

### Battery

The battery BAT is, for example, a secondary battery such as a lithium ion battery. The battery BAT is configured to be charged with electric power introduced from an external power source 50 outside the vehicle, for example, a quick charger. The battery BAT mainly supplies electric power to a drive motor (not shown). In addition, the battery BAT is also configured to be charged with electric power supplied during regeneration of the drive motor.

### Temperature Adjustment Device

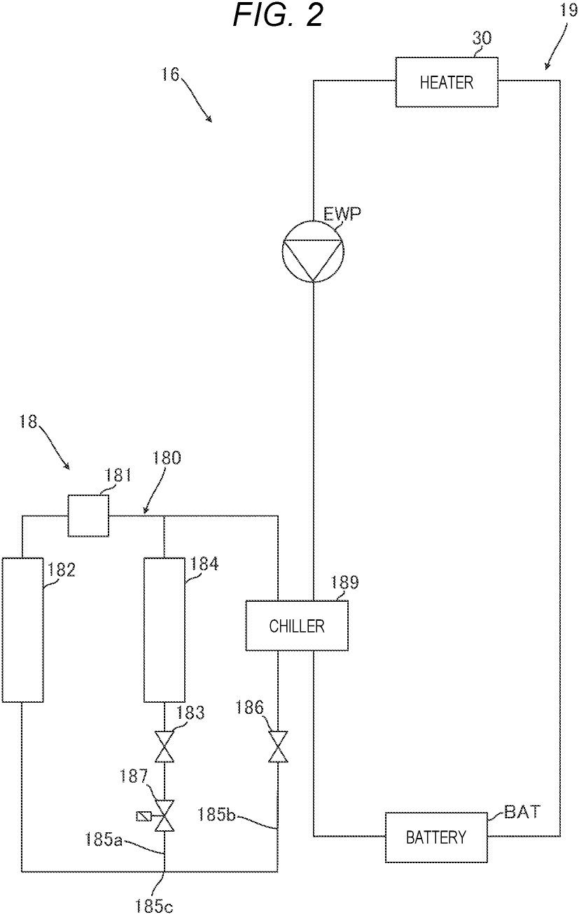

As shown in FIG. 2, the temperature adjustment device 16 includes an air conditioning device (air conditioner) 18 and a battery temperature adjustment circuit 19. It should be noted that hereinafter, the air conditioning device 18 is referred to as an air conditioner 18. The air conditioner 18 includes a refrigeration cycle 180. and adjusts environment in a vehicle cabin by adjusting a state of air in the vehicle cabin. The air conditioner 18 is controlled by a temperature adjustment control unit 21, which will be described later, and which receives an operation of an occupant (hereinafter, also referred to as a user). The battery temperature adjustment circuit 19 cools or heats the battery BAT and the like by causing a refrigerant to flow through a refrigerant flow path. An operation of the battery temperature adjustment circuit 19 is controlled by the temperature adjustment control unit 21 based on a temperature adjustment capability of the battery temperature adjustment circuit 19 such that a temperature of the battery BAT is within a target temperature range. Hereinafter, the control is referred to as normal battery cooling control, but the operation of the battery temperature adjustment circuit 19 is also controlled by cooling capacity distribution control, which will be described later, in addition to the normal battery cooling control.

In the temperature adjustment device 16, the refrigeration cycle 180 of the air conditioner 18 and the battery temperature adjustment circuit 19 are configured such that refrigerants thereof can exchange heat with each other via a chiller 189.

More specifically, with reference to FIG. 2, in the refrigeration cycle 180 of the air conditioner 18, a compressor 181, a condenser 182, an expansion valve 183, and an evaporator 184 are provided in series, and a second flow path 185b in which another expansion valve 186 and the chiller 189 are disposed is provided in parallel with a first flow path 185a in which the expansion valve 183 and the evaporator 184 are disposed. In addition, a shutoff valve 187 is provided between the expansion valve 183 and a branch portion 185c of the first flow path 185a and the second flow path 185b, and the refrigerant flows to both the first flow path 185a and the second flow path 185b by setting the shutoff valve 187 to an ON state, and the refrigerant flows only to the second flow path 185b by setting the shutoff valve 187 to an OFF state.

In the battery temperature adjustment circuit 19, a pump EWP for supplying the refrigerant, the chiller 189, the battery BAT, and a heater 30 are connected in series.

In the chiller 189, heat exchange is performed between the refrigerant of the refrigeration cycle 180 and the refrigerant of the battery temperature adjustment circuit 19. Therefore, in the temperature adjustment device 16, a cooling capacity of the refrigeration cycle 180 of the air conditioner 18 is distributed for the air conditioner and for battery cooling. That is, when the air conditioner 18 is not used (air conditioner OFF), the shutoff valve 187 is in the OFF state, and all the cooling capacity of the refrigeration cycle 180 can be used for the battery cooling. On the other hand, when the air conditioner 18 is used (air conditioner ON), the shutoff valve 187 is in the ON state, and the cooling capacity that can be used for the battery cooling among the cooling capacity of the refrigeration cycle 180 is reduced by an amount distributed for the air conditioner. Therefore, among the cooling capacity of the refrigeration cycle 180, the cooling capacity that can be used for the battery cooling depends on ON/OFF of the air conditioner 18. It should be noted that when the battery BAT is heated, the heater 30 may be turned on.

### Navigation Device

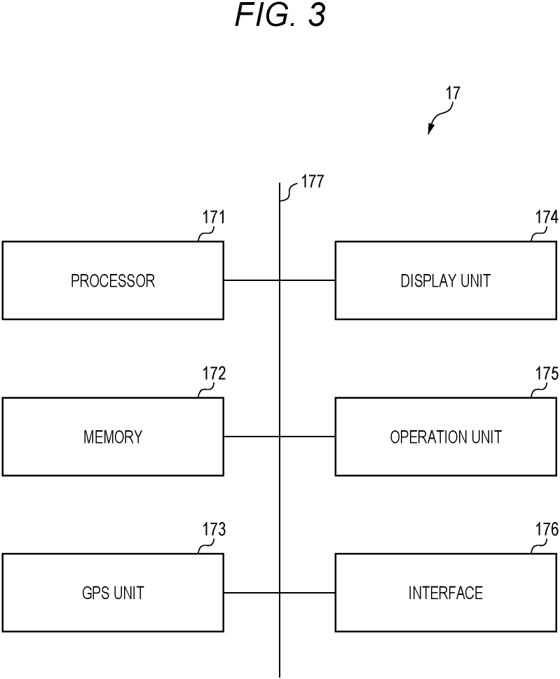

Next, an example of a configuration of a navigation device 17 will be described with reference to FIG. 3. As shown in FIG. 3, the navigation device 17 includes a processor 171. a memory 172, a GPS unit 173, a display unit 174, an operation unit 175, and an interface 176. Respective components 171 to 176 are connected to each other via a bus 177.

The processor 171 is, for example, a CPU that controls the entire navigation device 17. The memory 172 includes, for example, a main memory such as a RAM and an auxiliary memory which is a nonvolatile memory such as a flash memory. The main memory is used as a work area of the processor 171. The auxiliary memory stores various programs for operating the navigation device 17. The programs stored in the auxiliary memory are loaded into the main memory and are executed by the processor 171.

In addition, the auxiliary memory of the navigation device 17 also stores map data used for specifying a current position of the vehicle, making a route guidance to a destination, and the like. Although detailed description is omitted, the map data includes road data representing a road on which the vehicle can move, facility data representing information regarding each facility, and the like.

The GPS unit 173 receives a GPS signal (radio wave) from a GPS satellite and measures the current position of the vehicle. The current position measured by the GPS unit 173 is used to specify the current position of the vehicle.

The display unit 174 includes a display that displays a character and an image, a graphic controller that controls the entire display, and a buffer memory such as a video RAM (VRAM) that temporarily records image data of an image to be displayed on the display. The display is, for example, a liquid crystal display or an organic EL display.

The operation unit 175 inputs an operation signal corresponding to an operation received from the user to an inside (for example, the processor 171) of the navigation device 17. The operation unit 175 is, for example, a touch panel. In addition, the operation unit 175 may be a remote controller, a keyboard, a mouse, or the like including a plurality of keys.

The interface 176 controls input and output of data between the navigation device 17 and an outside (for example, a battery information acquisition unit 22, and a scheduled travel plan acquisition unit 23). The interface 176 is controlled by the processor 171. It should be noted that a part or all of the functions of the navigation device 17 may be implemented by, for example, functions of a terminal device such as a smartphone or a tablet terminal possessed by the user of the vehicle.

The navigation device 17 determines, for example, a route from a host vehicle position, which is the current position of the vehicle, to a destination set by the user of the vehicle, with reference to the map data or the like. In addition, the navigation device 17 acquires state of charge (SOC) information of the battery BAT from the battery information acquisition unit 22, creates a scheduled travel plan in which charging at a charging station is incorporated into a guidance route when charging is necessary, and guides the user by displaying the created scheduled travel plan on the display.

### Control Device

As shown in FIG. 1, the control device 20 includes the temperature adjustment control unit 21, the battery information acquisition unit 22, the scheduled travel plan acquisition unit 23, a target battery temperature setting unit 24, a normal battery cooling control planning unit 25, and a battery temperature adjustment plan creation unit 26. The control device 20 is implemented by an electronic control unit (ECU) including a processor, a memory, an interface, and the like. It should be noted that respective functional units may be configured as separate control devices.

The temperature adjustment control unit 21 controls the air conditioner 18 in accordance with a requirement of the user or the like, and controls the battery temperature adjustment circuit 19 by the normal battery cooling control and the cooling capacity distribution control.

The battery information acquisition unit 22 acquires a current temperature and a current cell voltage of the battery BAT from a sensor device (not shown), and estimates the SOC based on various kinds of information.

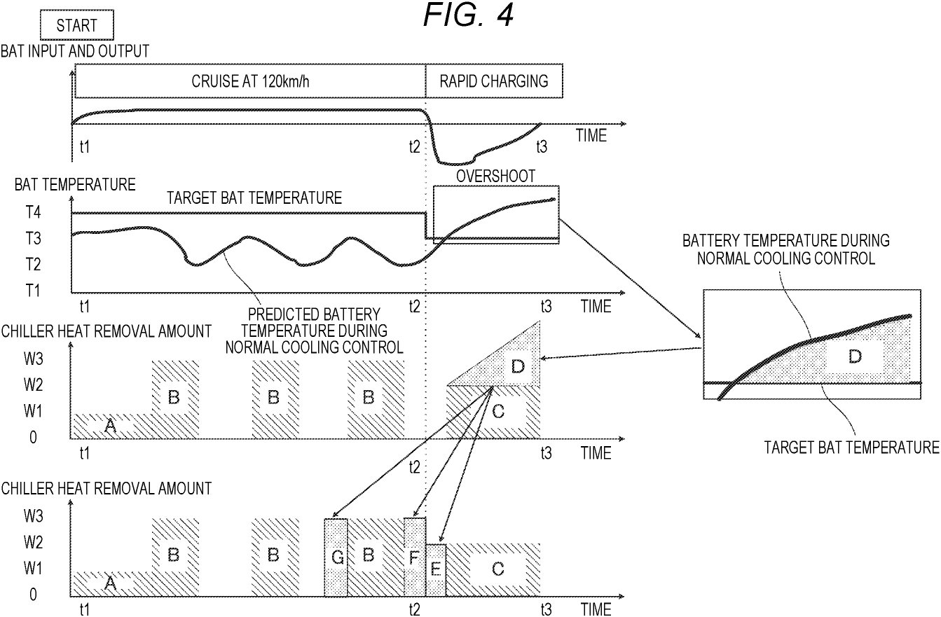

The scheduled travel plan acquisition unit 23 acquires the scheduled travel plan from the navigation device 17. FIG. 4 shows an example of the scheduled travel plan, and for example, the scheduled travel plan includes scheduled travel in which cruise travel is performed at a speed of 120 km/h from a time t1 to a time t2. and rapid charging is performed at a charging station from the time t2 to a time t3.

The normal battery cooling control planning unit 25 sets the normal battery cooling control such that the temperature of the battery BAT is within the target temperature range based on the temperature adjustment capability of the battery temperature adjustment circuit 19 according to the scheduled travel plan. It should be noted that the target temperature range is T2 (°C) to T3 (°C) in the present embodiment. In addition, the temperature adjustment capability of the battery temperature adjustment circuit 19 is a cooling capacity that can be used for battery cooling in the temperature adjustment device 16 when the battery BAT is cooled, and is the amount of heat by which the chiller 189 can reduce the heat of the refrigerant of the battery temperature adjustment circuit 19. Hereinafter, this amount of heat is referred to as a chiller heat removal amount.

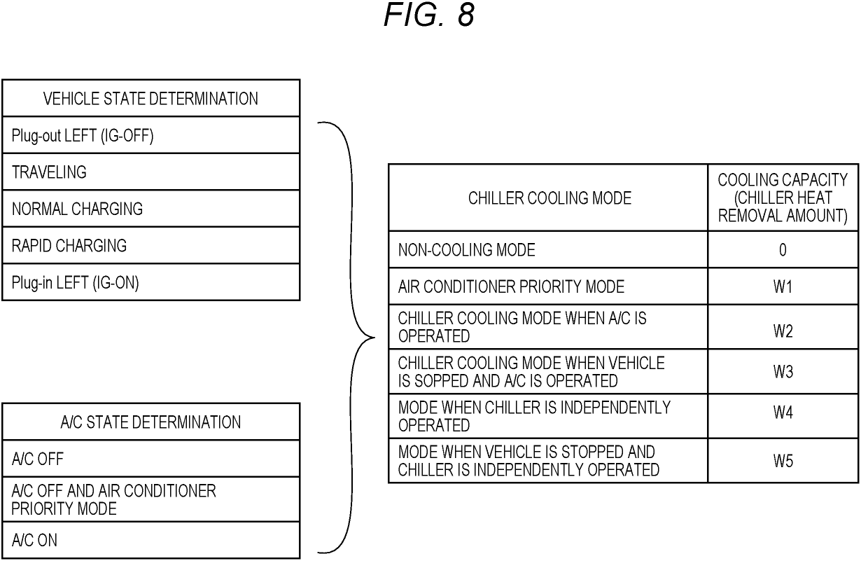

The temperature adjustment capability of the battery temperature adjustment circuit 19. that is, the chiller heat removal amount is determined based on a state of the vehicle and a state of the air conditioner 18. As shown in FIG. 8, the state of the vehicle is classified into, for example, five stages including a state in which the vehicle is left in a plug-out state (Plug-out left (IG-OFF)), traveling, normal charging, rapid charging, and a state in which the vehicle is left in a plug-in state (Plug-in left (IG-ON)). In addition, the state of the air conditioner 18 is classified into three stages including a state in which the air conditioner 18 is off (A/C_OFF), a state in which the air conditioner 18 is in an air conditioner priority mode (air conditioner priority mode), and a state in which the air conditioner 18 is on (A/C_ON). The air conditioner priority mode is a mode in which a temperature of the vehicle cabin is actively adjusted when the vehicle is started.

Then, the temperature adjustment capability is classified into five chiller cooling modes according to combinations of the state of the vehicle and the state of the air conditioner 18. The chiller cooling modes include six stages including a non-cooling mode, the air conditioner priority mode, a chiller cooling mode when an A/C is operated, a chiller cooling mode when a vehicle is sopped and an A/C is operated, a mode when a chiller is independently operated, and a mode when a vehicle is stopped and a chiller is independently operated. Cooling capacities (0 < W1 < W3 < W2 < W5 < W4) are set for the six stages of modes, respectively. Therefore, the battery temperature adjustment plan creation unit 26 can calculate, based on the scheduled travel plan, a predicted battery temperature and a cooling capacity of the battery temperature adjustment circuit 19, that is, a chiller heat removal amount at that time.

The normal battery cooling control planning unit 25 calculates a predicted battery temperature when the normal battery cooling control is performed in the scheduled travel plan and a chiller heat removal amount at that time. FIG. 4 shows the scheduled travel plan, and the predicted battery temperature and chiller heat removal amount (A to C in the figure) calculated by the normal battery cooling control planning unit 25. In FIG. 8, A/C means an air conditioner and IG means an ignition.

The target battery temperature setting unit 24 calculates an SOC transition of the battery BAT (hereinafter referred to as SOC transition) and a required BAT output based on the scheduled travel plan.

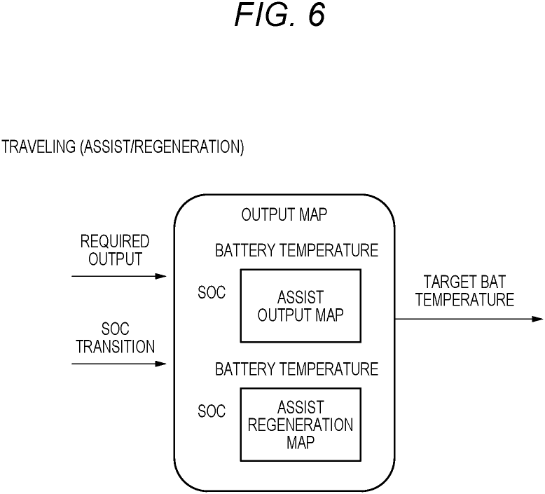

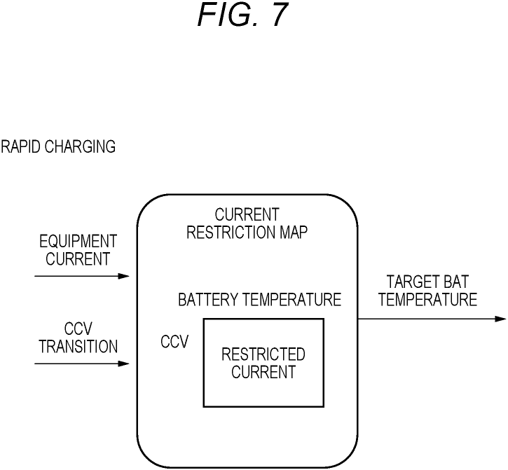

Further, the target battery temperature setting unit 24 sets a target BAT temperature based on the calculated SOC transition of the battery BAT and the required BAT output. For example, as shown in FIG. 6, during traveling in the scheduled travel plan, the target battery temperature setting unit 24 sets, based on the acquired SOC transition of the battery BAT and required BAT output, a target BAT temperature that satisfies a BAT output required in the future with reference to an SOC-battery temperature map. In addition, as shown in FIG. 7, during charging in the scheduled travel plan, the target battery temperature setting unit 24 acquires, from the navigation device 17 or a server device, a current (equipment current) of a charger of a charging station at which the vehicle will be charged and a transition of a closed circuit voltage (CCV), and sets a target BAT temperature during charging in the scheduled travel plan with reference to a CCV-battery temperature map such that BAT regeneration is not restricted. It should be noted that the target BAT temperature is lower than a power saving temperature at which power saving of the battery BAT is performed, and is equal to or higher than a high temperature-side target temperature (T3 (°C)) of the normal battery cooling control.

The battery temperature adjustment plan creation unit 26 creates a temperature adjustment plan for the battery BAT. The battery temperature adjustment plan creation unit 26 compares the predicted battery temperature calculated by the normal battery cooling control planning unit 25 with the target BAT temperature set by the target battery temperature setting unit 24, and calculates an insufficient battery cooling amount when the predicted battery temperature exceeds the target BAT temperature (so-called overshoot occurs). The insufficient battery cooling amount is a battery cooling amount required for making the predicted battery temperature equal to or lower than the target BAT temperature.

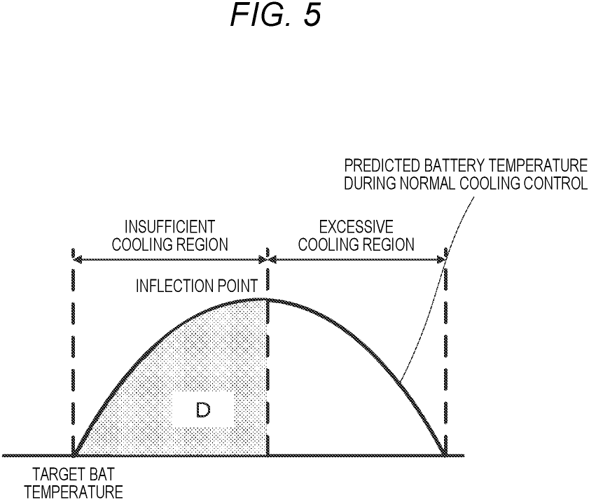

When the minimum value of the insufficient battery cooling amount is graphically represented, as shown in FIG. 5, the minimum value corresponds to an area between the predicted battery temperature and the target BAT temperature from a time when an overshoot occurs to an inflection point of the predicted battery temperature (D in FIG. 5).

When an overshoot is about to occur, the battery temperature adjustment plan creation unit 26 distributes the insufficient battery cooling amount before the overshoot occurs. By using the minimum value of the insufficient battery cooling amount described above, an overshoot can be prevented with minimum electric power consumption.

The battery temperature adjustment plan creation unit 26 allocates the insufficient battery cooling amount to a region where the battery cooling amount is zero in the normal battery cooling control, that is, a region corresponding to the non-cooling mode (hereinafter referred to as a chiller non-operating region) before the overshoot occurs.

Specifically, as shown in FIG. 4, the insufficient battery cooling amount is assigned to the chiller non-operating regions E to G in the order of E, F, and G from an overshoot occurrence time to a start time.

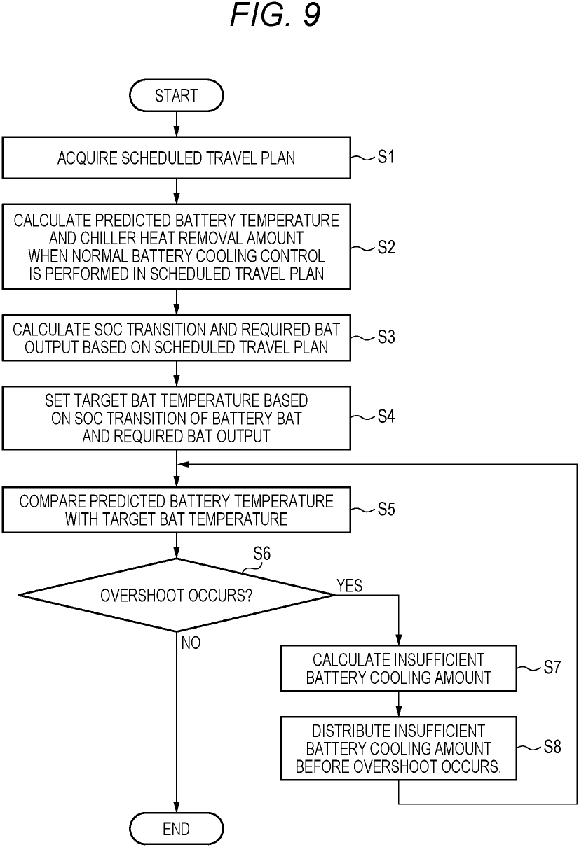

FIG. 9 is a flow diagram of the cooling capacity distribution control.

First, the scheduled travel plan acquisition unit 23 acquires the scheduled travel plan from the navigation device 17 (S1). Subsequently, the normal battery cooling control planning unit 25 calculates the predicted battery temperature and the chiller heat removal amount when the normal battery cooling control is performed in the scheduled travel plan (S2). In addition, the target battery temperature setting unit 24 calculates the SOC transition of the battery BAT (hereinafter referred to as SOC transition) and the required BAT output based on the scheduled travel plan (S3), and sets the target BAT temperature (S4). It should be noted that the order of step S2, step S3 and step S4 may be reversed, or step S2, step S3 and step S4 may be simultaneously performed.

The battery temperature adjustment plan creation unit 26 compares the predicted battery temperature with the target BAT temperature (S5). When an overshoot does not occur in which the predicted battery temperature exceeds the target BAT temperature (NO in S6), the process ends.

When an overshoot occurs in which the predicted battery temperature exceeds the target BAT temperature (YES in S6), the battery temperature adjustment plan creation unit 26 calculates an insufficient battery cooling amount (S7), and distributes the insufficient battery cooling amount before the overshoot occurs (S8). The battery temperature adjustment plan creation unit 26 repeats this process until the overshoot does not occur in all of the scheduled travel plans of steps S5 to S8.

Although embodiments for carrying out the present disclosure have been described above using the embodiment, the present disclosure is by no means limited to these embodiments, and various modifications and substitutions can be made without departing from the gist of the present disclosure.

In addition, at least the following matters are described in the present specification. It should be noted that in the parentheses, the corresponding constituent elements and the like in the above embodiments are shown, and the present disclosure is not limited thereto.

(1) A battery temperature adjustment system (battery temperature adjustment system 10), including:
a battery (battery BAT) configured to be charged with electric power from an external power source (external power source 50);
a battery temperature adjustment device (battery temperature adjustment circuit 19) configured to adjust a temperature of the battery; and
a control device (control device 20) configured to control the battery and the battery temperature adjustment device, in which
   the control device includes
      a scheduled travel plan acquisition unit (scheduled travel plan acquisition unit 23) configured to acquire a scheduled travel plan of a vehicle,
      a normal battery cooling control planning unit (normal battery cooling control planning unit 25) configured to plan normal battery cooling control such that the temperature of the battery is within a target temperature range, and derive a predicted battery temperature and a temperature adjustment capability of the battery temperature adjustment device in the normal battery cooling control, and
      a temperature adjustment plan creation unit (battery temperature adjustment plan creation unit 26) configured to create a temperature adjustment plan for the battery,
         the temperature adjustment plan creation unit
         derives a battery temperature adjustment amount required for making the temperature of the battery equal to or lower than a predetermined temperature when it is predicted that an overshoot occurs in which the predicted battery temperature exceeds the predetermined temperature, and
         distributes the battery temperature adjustment amount based on the temperature adjustment capability of the battery temperature adjustment device before the overshoot occurs.

According to (1), a plan is made in advance to, in the case in which the predicted battery temperature when the normal battery cooling control is performed in the scheduled travel plan exceeds the predetermined temperature, derive the battery temperature adjustment amount required for making the temperature of the battery equal to or lower than the predetermined temperature, and distribute the battery temperature adjustment amount before the overshoot occurs, so that it is possible to avoid restriction to the output of the battery after departure, and to avoid extension of an arrival time at the destination. In addition, since the required battery temperature adjustment amount is distributed based on the temperature adjustment capability of the battery temperature adjustment device, deterioration of convenience can be prevented.

(2) The battery temperature adjustment system according to (1), in which

the temperature adjustment plan creation unit preferentially distributes the battery temperature adjustment amount in order from an overshoot occurrence time to a start time so as not to exceed the temperature adjustment capability of the battery temperature adjustment device.

According to (2), the battery temperature adjustment amount is preferentially distributed in order from the overshoot occurrence time to the start time, so that occurrence of the overshoot can be avoided more appropriately.

(3) The battery temperature adjustment system according to (1) or (2), further comprising:
an air conditioning device (air conditioning device 18) configured to adjust a temperature in a vehicle cabin: and
a heat exchange unit (chiller 189) configured to exchange heat between a refrigerant of the battery temperature adjustment device and a refrigerant of the air conditioning device.

According to (3), since the heat exchange unit configured to exchange the heat between the refrigerant of the battery temperature adjustment device and the refrigerant of the air conditioning device is included, a refrigeration cycle of the battery temperature adjustment device and the air conditioning device can be prevented from increasing in size.

(4) The battery temperature adjustment system according to (3), in which

a distribution destination to which the battery temperature adjustment amount is distributed is a region in which the heat exchange unit is not operated under the normal battery cooling control.

According to (4), in the system that distributes the cooling capacity between the air conditioning device and the battery temperature adjustment device, the battery temperature adjustment amount is distributed to the region in which the heat exchange unit is not operated, so that a temperature adjustment capability of the heat exchange unit can be effectively used.

(5) The battery temperature adjustment system according to (3) or (4), in which

a cooling capacity of the battery temperature adjustment device is determined based on a state of the vehicle and a state of the air conditioning device.

According to (5), in the system that distributes the cooling capacity between the air conditioning device and the battery temperature adjustment device, the cooling capacity of the battery temperature adjustment device can be appropriately determined.

(6) The battery temperature adjustment system according to any one of (1) to (5), in which
the control device further includes a target battery temperature setting unit (target battery temperature setting unit 24) configured to set a target battery temperature which is the predetermined temperature, and
the target battery temperature setting unit calculates a state-of-charge (SOC) transition of the battery and a required battery output based on the scheduled travel plan, and sets the target battery temperature during traveling of the vehicle based on the calculated state-of-charge (SOC) transition of the battery and the required battery output.

According to (6), the target battery temperature during traveling of the vehicle for determining whether an overshoot occurs can be appropriately set.

(7) The battery temperature adjustment system according to any one of (1) to (6), in which
the control device further includes a target battery temperature setting unit configured to set a target battery temperature which is the predetermined temperature, and
the target battery temperature setting unit acquires information regarding a charging facility from the scheduled travel plan and sets the target battery temperature during charging of the vehicle based on the information regarding the charging facility.

According to (7), the target battery temperature during charging of the vehicle for determining whether an overshoot occurs can be appropriately set.

1. A battery temperature adjustment system comprising:
a battery configured to be charged with electric power from an external power source;
a battery temperature adjustment device configured to adjust a temperature of the battery; and
a control device configured to control the battery and the battery temperature adjustment device, wherein:
the control device includes:
a scheduled travel plan acquisition unit configured to acquire a scheduled travel plan of a vehicle;
a normal battery cooling control planning unit configured to plan normal battery cooling control such that the temperature of the battery is within a target temperature range, and derive a predicted battery temperature and a temperature adjustment capability of the battery temperature adjustment device in the normal battery cooling control; and
a temperature adjustment plan creation unit configured to create a temperature adjustment plan for the battery;
the temperature adjustment plan creation unit derives a battery temperature adjustment amount required for making the temperature of the battery equal to or lower than a predetermined temperature when an occurrence of overshoot, in which the predicted battery temperature exceeds the predetermined temperature, is predicted: and
the temperature adjustment plan creation unit distributes the battery temperature adjustment amount based on the temperature adjustment capability of the battery temperature adjustment device before the overshoot occurs.

2. The battery temperature adjustment system according to claim 1, wherein
the temperature adjustment plan creation unit preferentially distributes the battery temperature adjustment amount in order from an overshoot occurrence time to a start time so as not to exceed the temperature adjustment capability of the battery temperature adjustment device.

3. The battery temperature adjustment system according to claim 1, further comprising:
an air conditioning device configured to adjust a temperature in a vehicle cabin; and
a heat exchange unit configured to exchange heat between a refrigerant of the battery temperature adjustment device and a refrigerant of the air conditioning device.

4. The battery temperature adjustment system according to claim 3, wherein
a distribution destination to which the battery temperature adjustment amount is distributed is a region in which the heat exchange unit is not operated under the normal battery cooling control.

5. The battery temperature adjustment system according to claim 3, wherein
a cooling capacity of the battery temperature adjustment device is determined based on a state of the vehicle and a state of the air conditioning device.

6. The battery temperature adjustment system according to claim 1, wherein:
the control device further includes a target battery temperature setting unit configured to set a target battery temperature which is the predetermined temperature; and
the target battery temperature setting unit calculates a state-of-charge transition of the battery and a required battery output based on the scheduled travel plan, and sets the target battery temperature during traveling of the vehicle based on the state-of-charge transition of the battery and the required battery output.

7. The battery temperature adjustment system according to claim 1, wherein:
the control device further includes a target battery temperature setting unit configured to set a target battery temperature which is the predetermined temperature; and
the target battery temperature setting unit acquires information regarding a charging facility from the scheduled travel plan and sets the target battery temperature during charging of the vehicle based on the information regarding the charging facility.
